(19) United States
(12) Patent Application Publication
(10) Pub. No.: US 2008/0294858 A1
(43) Pub. Date: Nov. 27, 2008

(54) Storage system and data management method

(75) Inventors: Kosuke Sakai, Isehara (JP); Koji Nagata, Kaisei (JP); Masaaki Kobayashi, Odawara (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/007,331

(22) Filed: Jan. 9, 2008

(30) Foreign Application Priority Data
May 25, 2007 (JP) 2007-138540

(51) Int. Cl. G06F 12/00

(52) U.S. Cl. 711/161; 711/E12.103

(57) ABSTRACT

Provided are a storage system and a data management method capable of simplifying the operation of pair configuration by storing information concerning the pair configuration as pair definition information in a storage apparatus. This storage system includes one or more storage controllers for storing data sent from a host system, and a management terminal for managing the input and output of data stored in the one or more storage controllers. In this storage system, the one or more storage controllers include a storage unit for forming two or more logical volumes to be pair-configured in a storage area of a plurality of hard disk drives, and storing as pair definition information the status of not executing initial copy of data to be stored in a pair-configured copy source logical volume to a copy destination logical volume based on a command from the management terminal.

### CROSS REFERENCES

This application relates to and claims priority from Japanese Patent Application No. 2007-138540, filed on May 25, 2007, the entire disclosure of which is incorporated herein by reference.

### BACKGROUND

The present invention generally relates to a storage system and a data management method, and in particular relates to technology for using pair definition of logical volumes among a plurality of host systems.

In recent years, a storage apparatus for controlling the input and output of data from a host system in order to store large volumes of data sent from such host system is used in a storage system that handles large-capacity data.

A storage apparatus manages a plurality of disk drives arranged in an array according to RAID (Redundant Array of Independent Inexpensive Disks). At least one or more logical volumes (hereinafter referred to as “logical volumes”) are formed on a physical storage area provided by the plurality of disk drives, and these logical volumes are provided to the host system.

The host system recognizes a logical volume as one physical device and performs data access to the logical volume, and the management terminal manages the storage apparatus managed under RAID.

When backing up data in preparation for a disaster or the like in this kind of storage system, a system is configured where a primary logical volume and a secondary logical volume are formed into a pair, and data is stored in such pair-configured logical volume.

Upon creating this kind of pair configuration, since it is necessary to change information concerning the storage configuration, measures are taken to smoothly change the storage configuration information.

For example, Japanese Patent Laid-Open Publication No. 2005-44199 (Patent Document 1) discloses a storage system where, when a management terminal changes information concerning the storage configuration acquired from a storage apparatus and sends this as change information to a host system, the host system issues a command for changing the configuration to the storage apparatus based on the change information.

### SUMMARY

When a user is to create a pair configuration, such pair configuration is stored by the user inputting a command based on a command line on the host system side under a CUI (Character User Interface) environment.

In addition, in order to issue a pair creation command for actually executing the copy of logical volumes to a storage apparatus based on a command line, information concerning the pair configuration must be stored in each host system connected to the storage apparatus.

Thus, when the host system malfunctions due to a disaster, when a user is not able to directly access the host system since the user is not permitted access, or when the management terminal is to be directly connected to the storage apparatus, there is a problem in that it is not possible to operate the pair configuration and issue a pair creation command.

Further, the parameters to be input during the operation of the pair configuration need to be provided by the user during each execution. In addition, when executing a plurality of pair configurations, operation of the pair configuration becomes complex.

The present invention was devised in light of the foregoing points. Thus, an object of the present invention is to propose a storage system and a data management method enabling the simple operation of pair configuration by storing information concerning the pair configuration as definition information in the storage apparatus.

In order to achieve the foregoing object, the present invention provides a storage system comprising one or more storage controllers for storing data sent from a host system, and a management terminal for managing the input and output of data stored in the one or more storage controllers. In this storage system, the one or more storage controllers have two or more logical volumes to be pair-configured in a storage area of a plurality of hard disk drives, and include a storage unit for storing as pair definition information the status of not executing initial copy of data to be stored in a pair-configured copy source logical volume to a copy destination logical volume based on a command from the management terminal.

Thereby, definition information concerning the pair configuration can be stored in the storage apparatus.

The present invention further provides a data management method of a storage system comprising one or more storage controllers for storing data sent from a host system, and a management terminal for managing the input and output of data stored in the one or more storage controllers. In this data management method, the one or more storage controllers include a step of forming two or more logical volumes to be pair-configured in a storage area of a plurality of hard disk drives, and a step of storing as pair definition information the status of not executing initial copy of data to be stored in a pair-configured copy source logical volume to a copy destination logical volume based on a command from the management terminal.

Thereby, definition information concerning the pair configuration can be stored in the storage apparatus.

According to the present invention, since definition information concerning the pair configuration can be shared as a result of storing such definition information concerning the pair configuration in a storage apparatus, the takeover of definition information can be facilitated even when another management terminal is connected to the storage apparatus.

Further, according to the present invention, since definition information concerning the pair configuration is stored in the storage apparatus, operability concerning the pair configuration can be simplified from the display screen of the management terminal under the GUI (Graphical User Interface) environment.

### DESCRIPTION OF DRAWINGS

FIG. 1 is a block diagram showing the overall configuration of a storage system according to an embodiment of the present invention;

FIG. 2 is a diagram showing the contents of a local memory according to an embodiment of the present invention;

FIG. 3 is a chart showing consistency group definition information according to an embodiment of the present invention;

FIG. 4 is a chart showing pair definition information according to an embodiment of the present invention;

FIG. 5 is a chart showing pair status information according to an embodiment of the present invention;

FIG. 6 is a chart showing security definition information according to an embodiment of the present invention;

FIG. 7 is a screen transition diagram of a management terminal according to an embodiment of the present invention;

FIG. 8 is a screen diagram of a consistency group definition list according to an embodiment of the present invention;

FIG. 9 is a screen diagram of a consistency group definition creation list according to an embodiment of the present invention;

FIG. 10 is a screen diagram of a pair definition list according to an embodiment of the present invention;

FIG. 11 is a screen diagram of a pair definition creation list according to an embodiment of the present invention;

FIG. 12 is a screen diagram of a consistency group status list according to an embodiment of the present invention;

FIG. 13 is a screen diagram of a pair status list according to an embodiment of the present invention;

FIG. 14 is an explanatory diagram of a pair status list according to an embodiment of the present invention;

FIG. 15 is a screen diagram of pair creation according to an embodiment of the present invention;

FIG. 16 is a sequential diagram for storing consistency group definition information in a storage apparatus according to an embodiment of the present invention;

FIG. 17 is a sequential diagram for storing consistency group definition information in a storage apparatus according to an embodiment of the present invention;

FIG. 18 is a flowchart for creating a consistency group definition creation command according to an embodiment of the present invention;

FIG. 19 is a consistency group definition creation command chart according to an embodiment of the present invention;

FIG. 20 is a sequential diagram for storing pair definition information in a storage apparatus according to an embodiment of the present invention;

FIG. 21 is a sequential diagram for storing pair definition information in a storage apparatus according to an embodiment of the present invention;

FIG. 22 is a pair definition creation command chart according to an embodiment of the present invention;

FIG. 23 is a sequential diagram for executing pair creation according to an embodiment of the present invention;

FIG. 24 is a sequential diagram for executing pair creation according to an embodiment of the present invention;

FIG. 25 is a sequential diagram for executing pair creation according to an embodiment of the present invention;

FIG. 26 is a flowchart for performing pair creation processing according to an embodiment of the present invention; and

FIG. 27 is a flowchart for performing pair creation processing according to an embodiment of the present invention.

### DETAILED DESCRIPTION

### (1) First Embodiment

### (1-1) Storage System

The storage system according to the present embodiment will be described below.

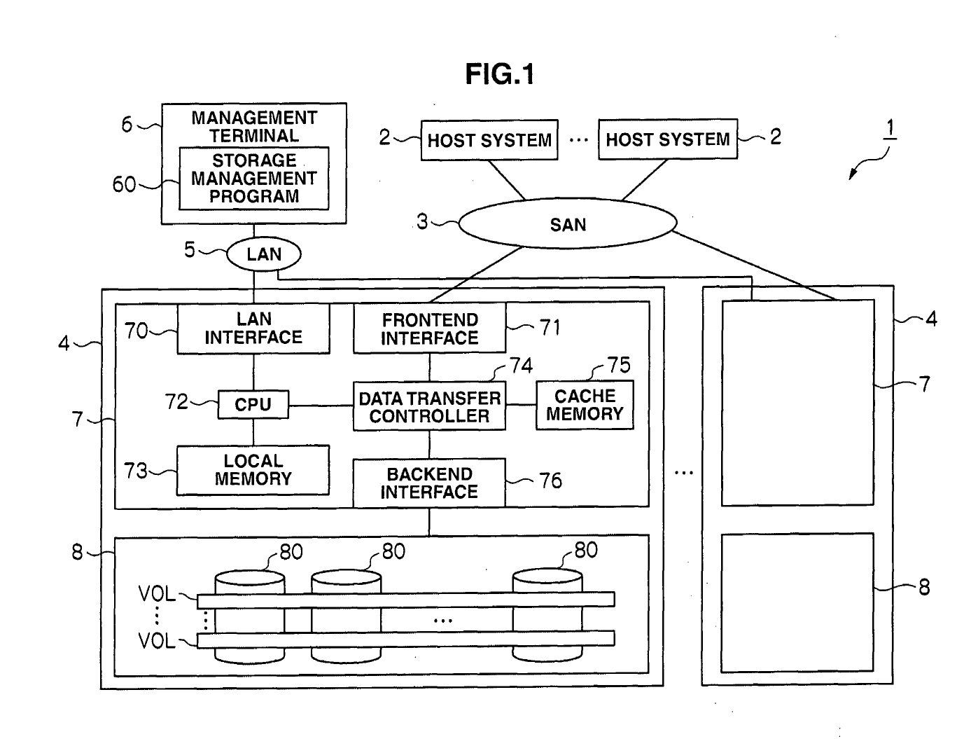

FIG. 1 shows the overall storage system 1 according to the present embodiment.

With this storage system 1, a plurality of host systems 2 are connected to a plurality of storage apparatuses 4 via a SAN (Storage Area Network) 3, and a plurality of storage apparatuses 4 are connected to a management terminal 6 via a LAN (Local Area Network) 5.

The host system 2 is a computer device comprising information processing resources such as a CPU (Central Processing Unit), a memory and so on, and, for instance, is configured from a personal computer, a workstation, a mainframe or the like. Further, the host system 2 comprises an information input device (not shown) such as a keyboard, a switch, a pointing device, a microphone or the like, and an information output device (not shown) such as a monitor display, a speaker or the like.

The storage apparatus 4 is a storage controller, and primarily comprises a controller 7 and a memory apparatus 8.

The controller 7 comprises a LAN interface 70, a frontend interface 71, a CPU 72, a local memory 73, a data transfer controller 75, a cache memory 75, and a backend interface 76.

The controller 7 is able to control a plurality of hard disk drives 80 based on a RAID level (for instance, level 0, 1 or 5) defined in a so-called RAID system. In a RAID system, a plurality of hard disk drives 80 are managed as a single RAID group. A plurality of logical volumes VOL are defined in the RAID group as access units from the host system 2. A LUN (Logical Unit Number) is allocated to each logical volume VOL.

The CPU 72 is a processor that controls the write access or read access to a plurality of hard disk drives 80 in response to a data I/O request from the host system 2. Further, the CPU 72 is a processor that executes processing according to various commands sent from the management terminal 6 and processing of programs stored in the local memory 73.

The local memory 73 stores various types of information 730 to 733 and a pair creation program 734 for creating pairs. The various types of information will be described later.

The data transfer controller 74 connects the cache memory 75, the frontend interface 71, the backend interface 76 and the CPU 72, and controls the data transfer between the host system 2 and the hard disk drives 80.

The cache memory 75 is a buffer memory for temporarily storing the write data to be written into the hard disk drives 80 or the read data to be read from the hard disk drives 80. The power source of the cache memory 75 is backed up, and is configured as a nonvolatile memory for preventing the loss of cache data even when a power failure occurs to the storage apparatus 4.

When a write access from the host system 2 is requested, the data transfer controller 74 foremost writes the data received from the host system 2 via the frontend interface 71 into the cache memory 75. Subsequently, the data transfer controller 74 transfers the write data to the backend interface 76 in order to asynchronously write such write data into the hard disk drives 80.

Further, when a read access from the host system 2 is requested, the data transfer controller 74 writes the read data read from the hard disk drives 80 into the cache memory 75 via the backend interface 76, and transfers such read data to the frontend interface 71.

The frontend interface 71 is a controller for controlling the interface with the host system 2, and, for instance, has a function of receiving a block access request from the host system 2 based on a fibre channel protocol.

The backend interface 76 is a controller for controlling the interface with the hard disk drives 80, and, for instance, has a function of controlling the data I/O requests to the hard disk drives 80 based on a protocol for controlling the hard disk drives 80.

The LAN interface 70 is an interface for connecting to the LAN, and controls the sending and receiving of data and control signals to and from the management terminal based on TCP/IP.

The memory apparatus 8 comprises a plurality of hard disk drives 80. The hard disk drives 80 are storage devices configured from FC (Fibre Channel) disk drives, SATA (Serial Advanced Technology Attachment) disk drives, PATA (Parallel Advanced Technology Attachment) disk drives, FATA (Fibre Advanced Technology Attachment) disk drives, SAS (Serial Advanced SCSI) disk drives, SCSI (Small Computer System Interface) disk drives or the like.

The management terminal 6, for instance, is a computer system comprising hardware resources such as a CPU, a memory and a display. By using the management terminal 6 to perform input operations, the user is able to send commands for managing the storage apparatus 4 to the storage apparatus 4. As commands for managing the storage apparatus 4, for instance, there is a command for increasing or decreasing the hard disk drives 80 or changing the RAID configuration, a command for installing the CPU's micro programs in the memory, and a command for confirming the operational status and specifying the defective portion of the storage apparatus 4.

Further, the management terminal 6 stores the storage management program 60 capable of realizing the present embodiment.

The storage management program 60 is a program for storing various types of definition information in the local memory 73 of the storage apparatus 4. The CPU of the management terminal 6 executes the storage management program 60.

### (1-2) Configuration of Local Memory

The configuration of storing information and program in the local memory 73 is explained.

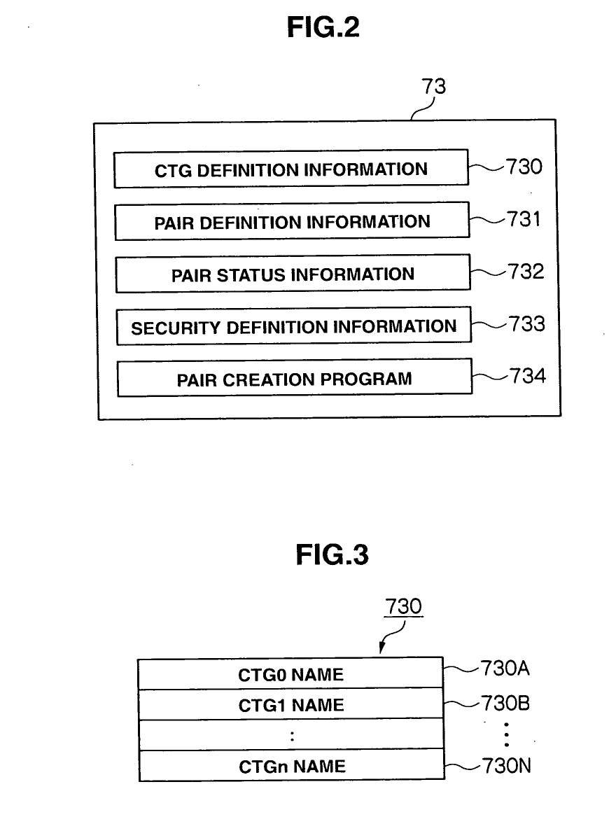

As shown in FIG. 2, the local memory 73 stores consistency group definition information (abbreviated as CTG definition information in the drawings) 730, pair definition information 731, pair status information 732, security information 733 and a pair creation program 734.

Incidentally, the consistency group is sometimes referred to as CTG in the subsequent drawings. Each type of information 730 to 733 is now explained.

(1-2-1) Consistency/Group Definition Information

FIG. 3 shows the consistency group definition information 730.

The consistency group definition information 730 stores the group definition for executing the pair configuration of the logical volume VOL.

Here, a consistency group refers to a group in which the same operation can be performed to a plurality of pair configurations at the same time.

A consistency group includes a copy type showing the type of copy to be performed to the plurality of pair configurations. As the copy type, there are shadow image (abbreviated as SI in the drawings), snapshot (abbreviated as SS in the drawings), true copy (abbreviated as TC in the drawings) and asynchronous true copy (abbreviated as TCE in the drawings).

A shadow image is a copy method of configuring a pair of two or more logical volumes VOL in the storage apparatus 4.

A snapshot is a copy method of copying data that was periodically acquired from a certain logical volume VOL to a separate logical volume VOL in the storage apparatus 4.

A true copy is a copy method of configuring a pair of the logical volumes VOL existing among the storage apparatuses 4, and is a synchronous copy method of reporting the write completion to the host system 2 under the condition that data is written into both logical volumes VOL.

An asynchronous true copy is a copy method of configuring a pair of the logical volumes VOL existing among the storage apparatuses 4, and is an asynchronous copy method of reporting the write completion to the host system 2 at the stage that data is written into the primary logical volume PVOL of the copy source, and asynchronously copying data of the primary logical volume PVOL to the secondary logical volume SVOL of the copy destination at a suitable timing.

The consistency group definition information 730 stores a CTG0 name 730A, a CTG1 name 730B . . . a CTG maximum value name 730N for each group. Incidentally, a name is an arbitrary name given by the user for making the operation easier to understand.

(1-2-2) Pair Definition Information

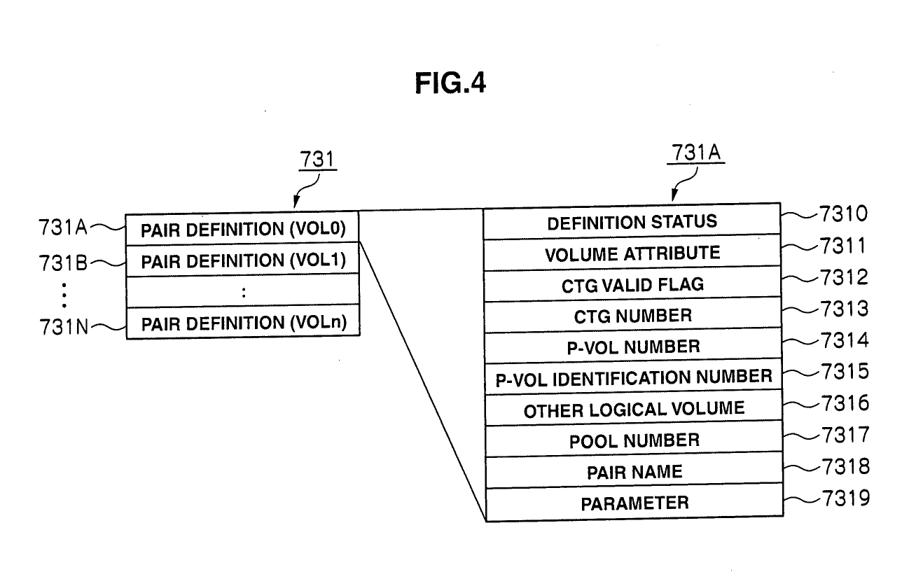

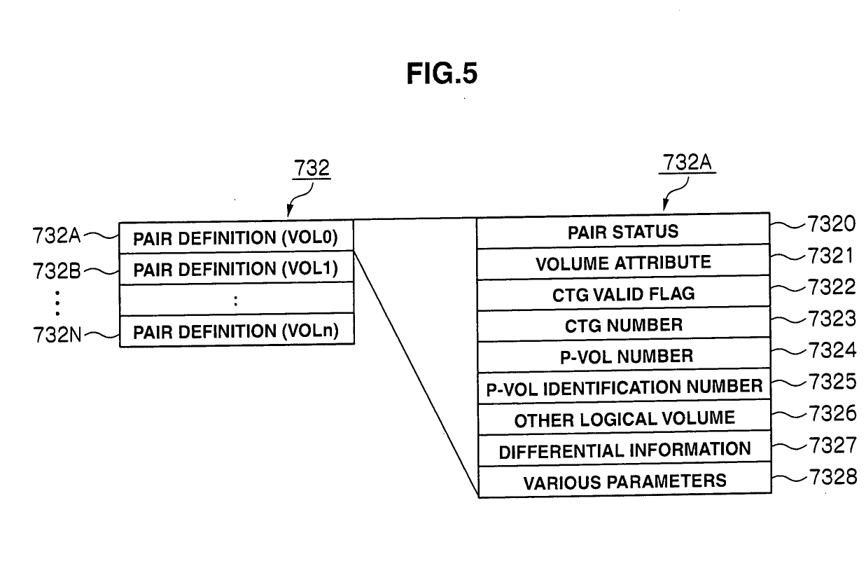

FIG. 4 shows the pair definition information 731.

The pair definition information 731 stores information concerning the pair definition set for each logical volume VOL. The pair definition information 731 stores a pair definition (VOL0) 731A, a pair definition (VOL1) 731B . . . a pair definition (VOLn) 731N.

Here, a pair definition is a status where only a pair is configured from two or more logical volumes VOL, and a status where initial copy is not executed to the pair-configured secondary logical volumes SVOL.

The pair definition information of each logical volume VOL stores various types of information.

The various types of information are information concerning a definition status 7310, a volume attribute 7311, a CTG valid flag 7312, a CTG number 7313, a P-VOL number 7314, a P-VOL identification number 7315, another logical volume 7316, a pool number 7317, a pair name 7318 and a parameter 7319.

The definition status 7310 is information showing whether the corresponding logical volume VOL has been subject to pair definition.

The volume attribute 7311 shows information on whether the corresponding logical volume VOL is a primary logical volume PVOL or a secondary logical volume SVOL.

The CTG valid flag 7312 shows information on whether the pair-defined logical volume VOL belongs to a consistency group.

The CTG number 7313 shows information of the affiliation number in a case where the pair-defined logical volume belongs to a consistency group.

The P-VOL number 7314 shows the information of the volume number of a primary logical volume PVOL when the corresponding logical volume VOL is a secondary logical volume SVOL.

The P-VOL identification number 7315 shows information of the identification number for identifying the primary logical volume PVOL when the primary logical volume PVOL and a plurality of secondary logical volumes SVOL are pair-configured, and the corresponding logical volume VOL is a secondary logical volume SVOL.

The other logical volume 7316 shows information concerning the apparatus number of the storage apparatus 4 providing the secondary logical volume SVOL and the volume number of the secondary logical volume SVOL when the corresponding logical volume VOL is a primary logical volume PVOL.

The pool number 7317 shows information on the pool number to be used by the corresponding logical volume VOL. A pool is a virtual storage area configured from the hard disk drives 80, and a logical volume VOL can be set by allocating the pool's capacity to the LUN.

The pair name 7318 shows information of the name given to the pair.

The parameter 7319 shows information on the copy speed upon copying data from the primary logical volume PVOL to the secondary logical volume SVOL.

Incidentally, among the various types of information of the pair definition information 731, information concerning the definition status 7310, the volume attribute 7311, the CTG valid flag 7312, the CTG number 7313, and the pair name 7318 is information to be applied to the shadow image, snapshot, true copy and asynchronous true copy.

In addition, information concerning the P-VOL number 7314 and the P-VOL identification number 7315 is information to be applied to the shadow image and snapshot.

Further, information concerning the apparatus number of the other logical volume 7316 is information to be applied to the true copy and asynchronous true copy.

Information concerning the pool number 7317 is information to be applied to the snapshot and asynchronous true copy.

(1-2-3) Pair Status Information

FIG. 5 shows the pair status information 732.

The pair status information 732 stores information concerning the pair status set for each logical volume VOL. The pair status information 732 stores a pair status (VOL0) 732A, a pair status (VOL1) 732B . . . a pair status (VOLn) 732N.

Here, a pair status is a status in which data in the primary logical volume PVOL has been copied to the pair-configured secondary logical volume SVOL based on initial copy.

The pair status information of each logical volume VOL includes various types of information.

The various types of information are information concerning a pair status 7320, a volume attribute 7321, a CTG valid flag 7322, a CTG number 7323, a P-VOL number 7324, a P-VOL identification number 7325, another logical volume 7326, differential information 7327, and various parameters 7328.

The pair status 7320 shows information of the current status concerning the pair-configured logical volume VOL. Regarding the pair status 7320, for instance, the pair-configured logical volume VOL stores information such as a status where the contents of the primary logical volume PVOL are currently split so that they are not reflected in the secondary logical volume SVOL, or a status where the contents of the primary logical volume PVOL are synchronously reflected in the secondary logical volume SVOL.

The volume attribute 7321, the CTG valid flag 7322, the CTG number 7323, the P-VOL number 7324, the P-VOL identification number 7325 and the other logical volume 7326 have the same contents as the volume attribute 7311, the CTG valid flag 7312, the CTG number 7313, the P-VOL number 7314, the P-VOL identification number 7315 and the other logical volume 7316 described above, and the explanation thereof is omitted.

The differential information 7327 shows the differential information of data arising as a result of splitting the primary logical volume PVOL and the secondary logical volume SVOL and not reflecting the contents of the primary logical volume PVOL in the secondary logical volume SVOL.

The various parameters 7328 show information on various parameter options to be designated by the user during pair operation. The various parameters are fence level, split/non-split after pair creation, read/write status to secondary logical volume SVOL after pair creation, copy speed, and so on.

Incidentally, among the various types of information of the pair status information 732, information concerning the pair status 7320, the volume attribute 7321, the CTG valid flag 7322, the CTG number 7323, the differential information 7327 and the various parameters 7328 is information to be applied to the shadow image, snapshot, true copy and asynchronous true copy.

In addition, information concerning the P-VOL number 7324 and the P-VOL identification number 7325 is information to be applied to the shadow image and snapshot.

Further, information concerning the apparatus number of the other logical volume 7326 is information to be applied to the true copy and asynchronous true copy.

(1-2-4) Security Information

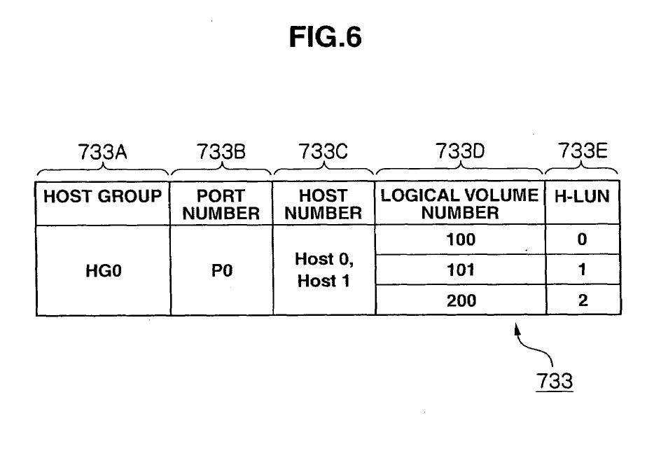

FIG. 6 shows the security information 733.

The security information 733 is information retained in the storage apparatus 4, and is security information of the logical volume VOL to be provided to the host system 2.

The security information 733 is configured from a “host group” field 733A, a “port number” field 733B, a “host number” field 733C, a “logical volume number” field 733D, and an “H-LUN” field 733E.

The “host group” field 733A stores logical group information created in the storage apparatus 4.

The “port number” field 733B stores port number information to be used in accessing the logical volume VOL designated by the host system 2.

The “host number” field 733C stores number information of the host system 2.

The “logical volume number” field 733D stores volume number information of the logical volume VOL designated by the host system 2.

The “H-LUN” field 733E stores volume number information in which the logical volume VOL designated by the host system 2 is converted into a logical volume VOL to be managed in the host system 2.

### (1-3) Screen of Management Terminal

The storage system 1 according to the present embodiment configured as described above is characteristic in that it stores the pair definition in the storage apparatus 4.

The GUI screen T1 to be used by the user when operating the management terminal 6 to configure settings in order to realize this characteristic is now explained.

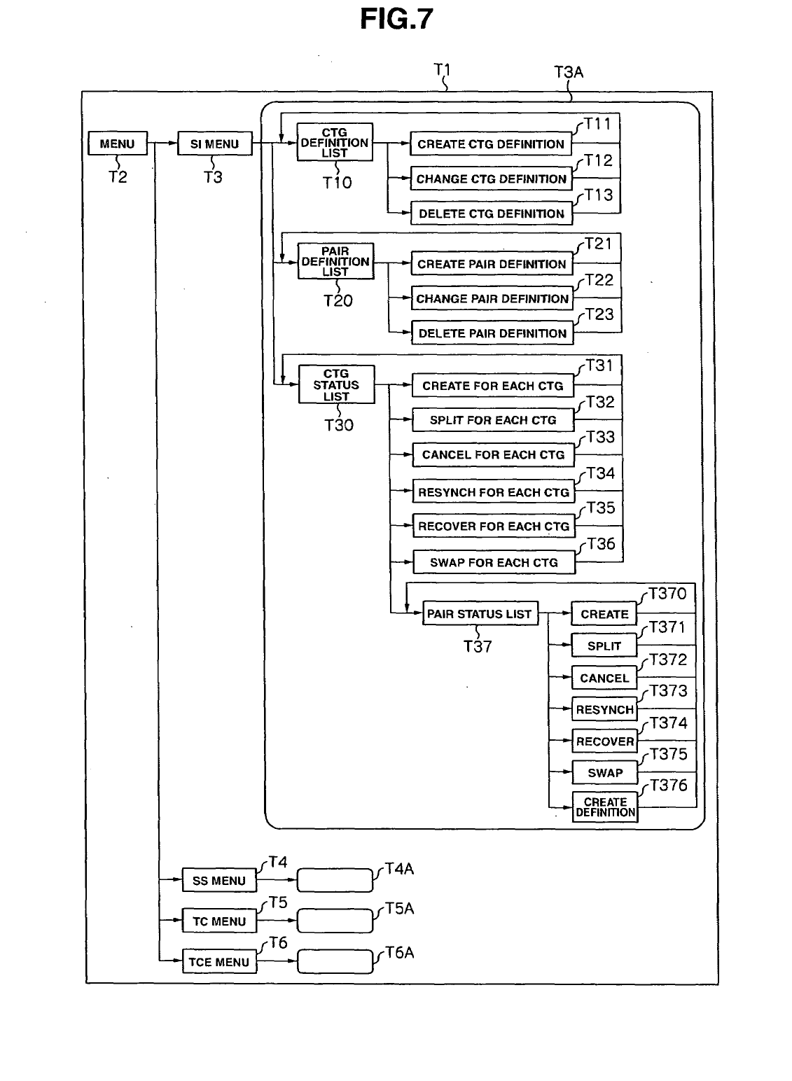

FIG. 7 is a transition diagram of the GUI screen T1 of the management terminal 6.

When the user clicks a “menu” T2 of the GUI screen T1, an “SI menu” T3, an “SS menu” T4, a “TC menu” T5 and a “TCE menu” T6 are displayed.

When the user clicks the “SI menu” T3, a “CTG definition list” T10, a “pair definition list” T20 and a “CTG status list” T30 are displayed.

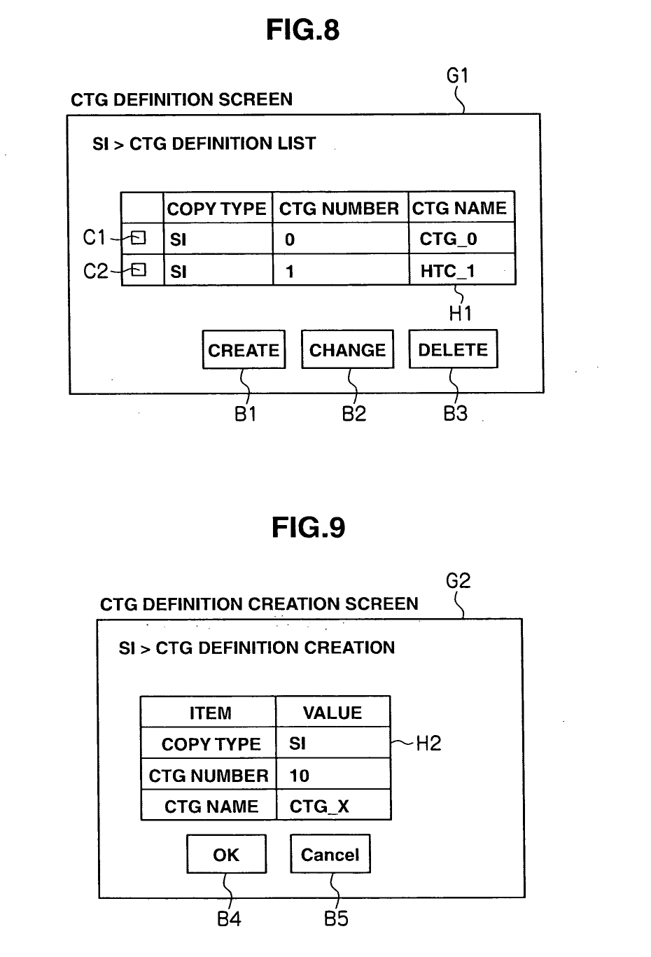

For example, when the user clicks the “CTG definition list” T10 depicted in FIG. 7, as shown in FIG. 8, a consistency group definition list screen G1 is displayed. The consistency group definition list G1 displays a chart H1 including a “copy type” field, a “CTG number” field and a “CTG name” field.

When the user wishes to create a definition of a consistency group from the chart H1, the user clicks the “Create” button B1 without checking the check boxes C1, C2.

Meanwhile, when the user wishes to change or delete a group that was output to the chart H1, the user checks the check boxes C1, C2. When the user who checked the check boxes C1, C2 clicks either the “Change” button B2 or the “Delete” button B3, processing according to the button name is executed.

Incidentally, when a user wishes to change or delete a plurality of consistency group definitions, the user checks a plurality of check boxes C1, C2.

FIG. 9 shows a CTG definition creation screen G2 when the user clicks the “Create” button B1.

The user inputs desired values for creating the definition in the “CTG number” and the “CTG name.” Incidentally, the “copy type” is automatically output. When the user who input the desired values selects and clicks the “OK” button B4 or the “Cancel” button B5, processing for creating or cancelling the creation of the consistency group definition is performed.

Returning to FIG. 7, when the user clicks the “pair definition list” T20 on the GUI screen T1, various items T21 to T23 are displayed.

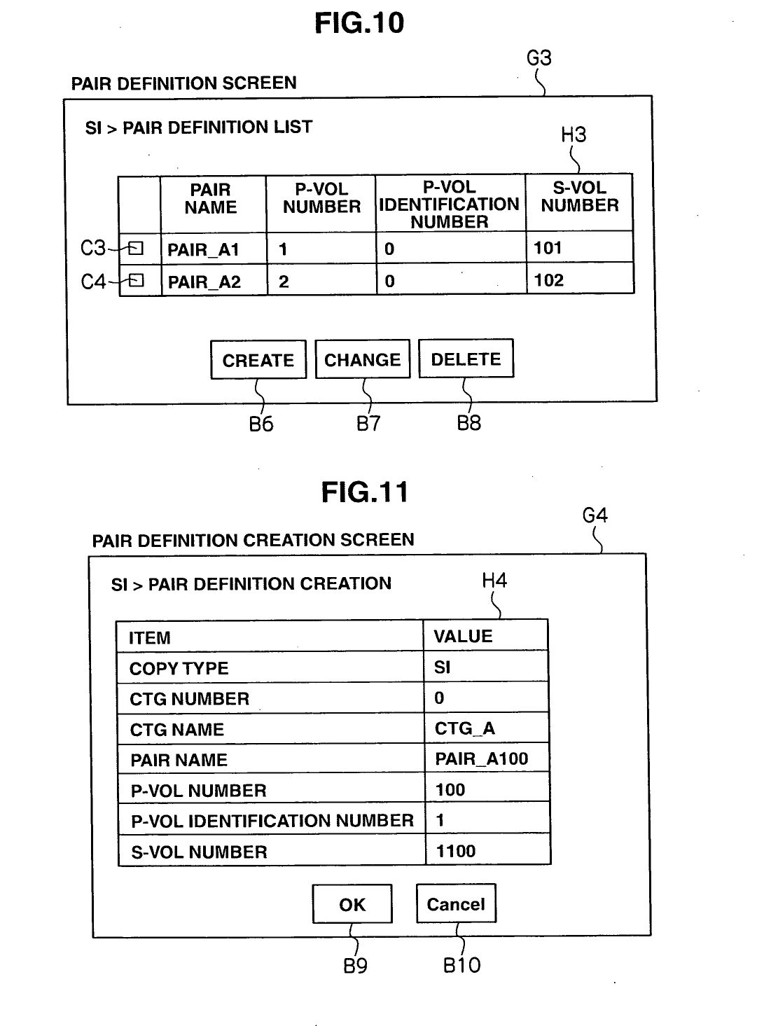

For example, when the user clicks the “pair definition list” T20 depicted in FIG. 7, as shown in FIG. 10, a pair definition list screen G3 is displayed. The pair definition list screen G3 displays a chart H3 including a “pair name” field, a “P-VOL number” field, a “P-VOL identification number” field and an “S-VOL number” field.

When the user wishes to create a pair definition from the chart H3, the user clicks the “Create” button B6 without checking the check boxes C3, C4.

Meanwhile, when the user wishes to change or delete a group that was output to the chart H3, the user checks the check boxes C3, C4. When the user who checked the check boxes C3, C4 clicks either the Change” button B7 or the “Delete” button B8, processing according to the button name is executed.

Incidentally, when a user wishes to change or delete a plurality of pair definitions, the user checks a plurality of check boxes C3, C4.

FIG. 11 shows a pair definition creation screen G4 when the user clicks the “Create” button B6. The user inputs desired values for creating a pair definition in the “pair name” field, the “P-VOL number” field, the “P-VOL identification number” field and the “S-VOL number” field configuring the chart H4.

Incidentally, the “copy type,” the “CTG number” and the “CTG name” are automatically output. When the user who input the desired values selects and clicks either the “OK” button B9 or the “Cancel” button B10, processing for creating or cancelling the creation of a pair definition is performed.

Returning to FIG. 7, when the user clicks the “CTG status list” T30 on the GUI screen T1, various items T31 to T37 are displayed.

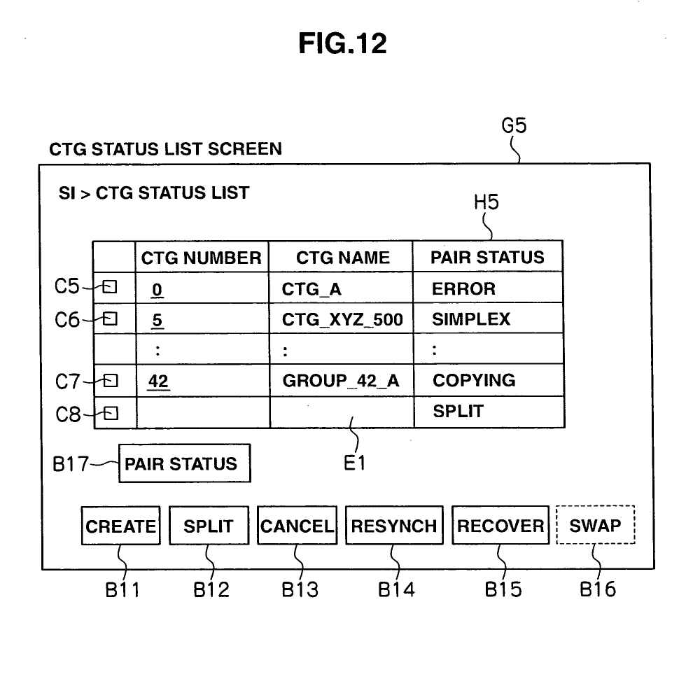

For example, when the user clicks the “CTG status list” T30 depicted in FIG. 7, as shown in FIG. 12, a consistency group status list screen G5 is displayed. The consistency group status list screen G5 displays a chart H5 configured from a “CTG number” field, a “CTG name” field and a “pair status” field. “Simplex” in the “pair status” field shows a status where only the CTG definition and pair definition were conducted, and initial copy has not been performed to the secondary logical volume SVOL.

When the user wishes to execute pair creation in the consistency group status shown in the chart H5, the user checks the check box C6 and clicks the “Create” button B11. Thereby, all pairs belonging to the consistency group “5” are created.

After checking either the check box C5 or C6, when the user selects the “Split” button B12, the “Cancel” button B13 for cancelling the pair configuration, the “Resynchronize” button B14 for resynchronizing the split pairs, the “Recover” button B15, the “Swap” button B16 or the “Pair Status” button B17, processing according to the button name is executed.

Incidentally, the “Recover” button B15 is a button for copying data in the secondary logical volume SVOL to the primary logical volume PVOL in order to return the primary logical volume PVOL to the status of the secondary logical volume SVOL.

Further, the “Swap” button B16 is a button for switching the primary logical volume PVOL and the secondary logical volume SVOL, making the secondary logical volume SVOL the primary logical volume PVOL after the switch, and copying data from the primary logical volume PVOL after the switch to the secondary logical volume SVOL after the switch. The button B16 is applied to the true copy and asynchronous true copy.

The “pair status” button B17 is a button for listing the pair status belonging to the checked consistency group.

Returning to FIG. 7, when the user clicks the “pair status list” T37, various items T370 to T376 are displayed.

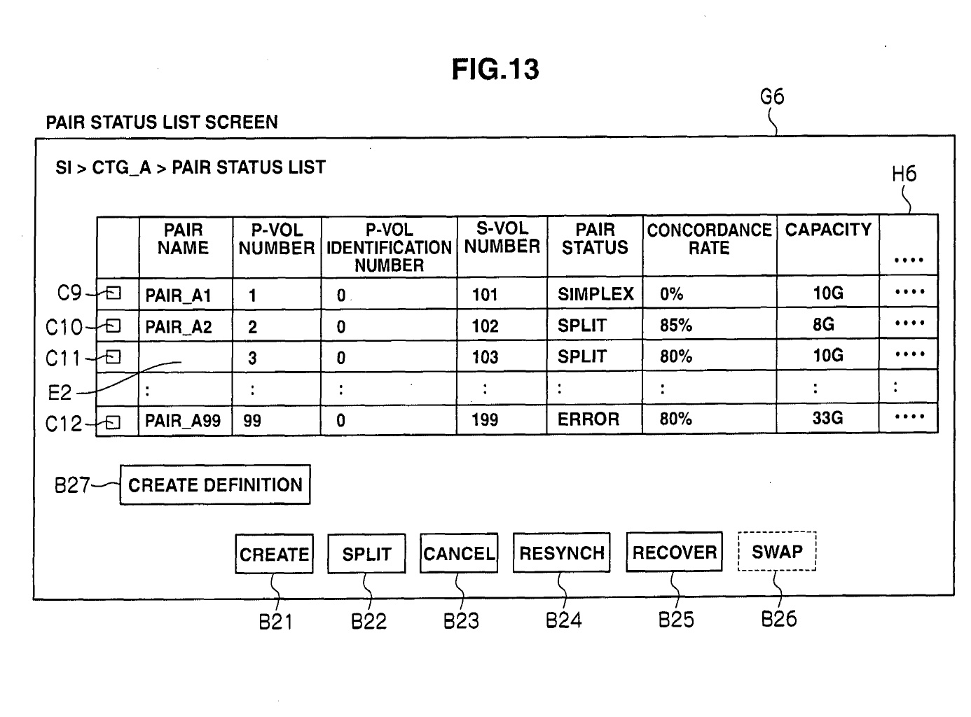

When the user clicks the “pair status list” T37 shown in FIG. 7, a pair status list screen G6 shown in FIG. 13 is displayed. The pair status list screen G6 displays a chart H6 configured from a “pair name” field, a “P-VOL number” field, a “P-VOL identification number” field, an “S-VOL number” field, a “pair status” field, a “concordance rate” field showing the concordance rate of the contents of the primary logical volume PVOL and the secondary logical volume SVOL, a “capacity” field showing the capacity of the primary logical volume PVOL and the secondary logical volume SVOL.

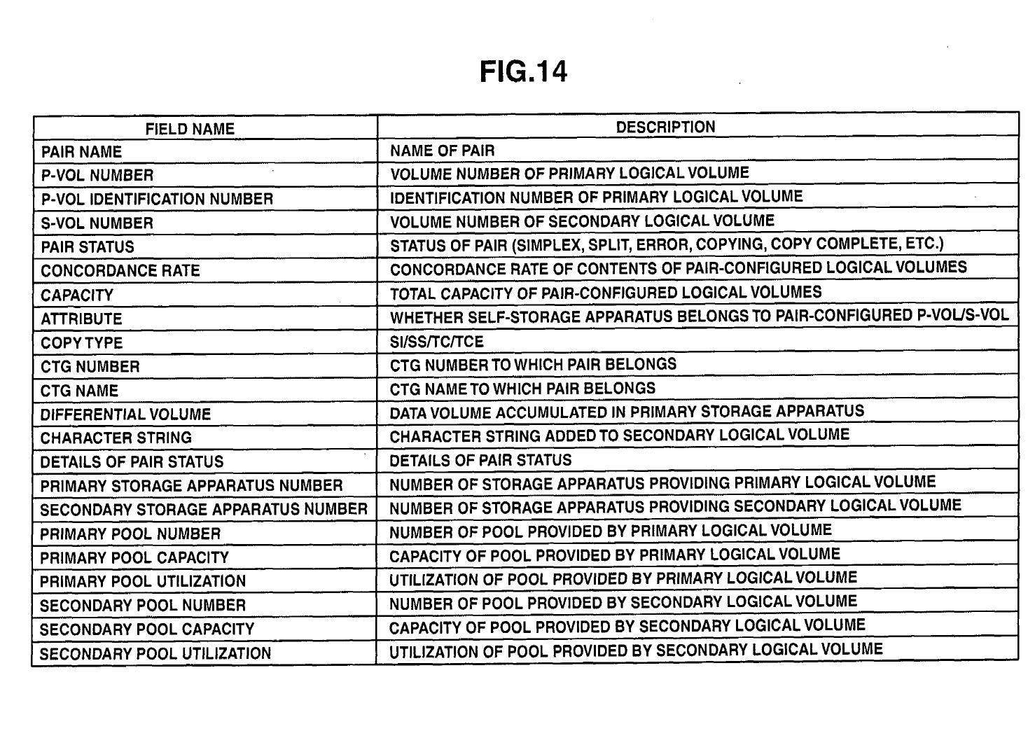

In addition, the “field name” configuring the fields of the pair status list H6 and the “contents” showing the specific contents of the field name are shown in FIG. 14.

Returning to FIG. 13, when the user wishes to execute pair creation in the pair status shown in the chart H6, the user checks the check box C9 and clicks the “Create” button B21.

Further, when the user checks one among the check boxes C9, C10, C12 and selects the “Split” button B22, the “Cancel” button B23, the “Resynchronize” button B24, the “Recover” button B25 or the “Swap” button B26, processing according to the button name is executed.

Further, when a pair is configured by the host system 2 based on a conventional method, since the “pair name” field is displayed as a blank column E2 as shown in FIG. 13, the user checks the check box C11 of the pair displayed in the blank column E2 and clicks the “Create Definition” button B27. Then, the management terminal 6 creates a pair definition from the pair status and sends it to the storage apparatus 4. The storage apparatus 4 stores the pair definition in the local memory 73 of the storage apparatus 4. Even when a pair is created in a status with no pair definition information, it is possible to create the pair definition information from the created pair and store it in the storage apparatus 4.

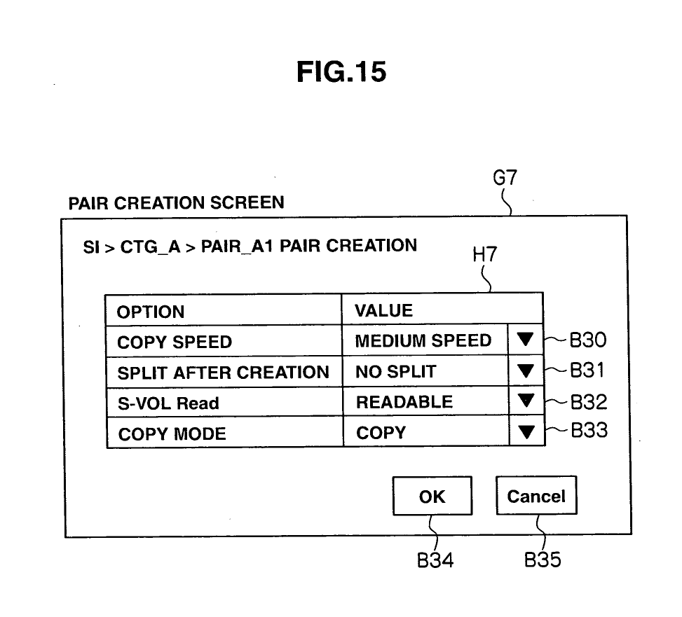

When the user clicks the “Create” button B21 shown in the chart H6, a “pair creation” screen G7 shown in FIG. 15 is displayed. The “pair creation” screen G7 displays a pair creation list H7 configured from an “option” field and a “value” field.

When setting the respective items in the “option” field, the user selects the values to be set from the pulldown buttons B30 to B33. When the user who selected the setting value clicks either the “OK” button B34 or the “Cancel” button B35, processing for setting or cancelling the setting of options is performed.

The transition diagram T3A of FIG. 7 shows that the screens G1 to G7 explained above are similarly displayed even when the “SS menu” T4, the “TC menu” T5 or the “TCE menu” T6 is selected (T4A, T5A, T6A).

Incidentally, it is possible to display an import menu and an export menu for inputting and outputting the consistency group definition information and the pair definition information as files on the menu screen T1 of the management terminal 6.

For example, when the user selects the export menu, the management terminal 6 is able to acquire the consistency group definition information 730 and the pair definition information 731 from the local memory 73 of the storage apparatus 4, and output the various acquired definition information 730, 731 as files to another storage apparatus 4. The user will set the output destination to which the file is to be output, and the file name.

Further, when the user selects the import menu, the management terminal 6 is able to store the consistency group definition information 730 and the pair definition information 731 designated by the user as files in the local memory 73 of the storage apparatus 4.

### (1-4) Storage Routine of Consistency/Group Definition Information

(1-4-1) Storage Processing Routine of Consistency/Group Definition Information

The processing routine of storing the consistency group definition information 730 in the storage apparatus 4 before storing the pair definition information 731 in the storage apparatus 4 is now explained. This storage processing routine is executed by the management terminal 6 based on the storage management program 60.

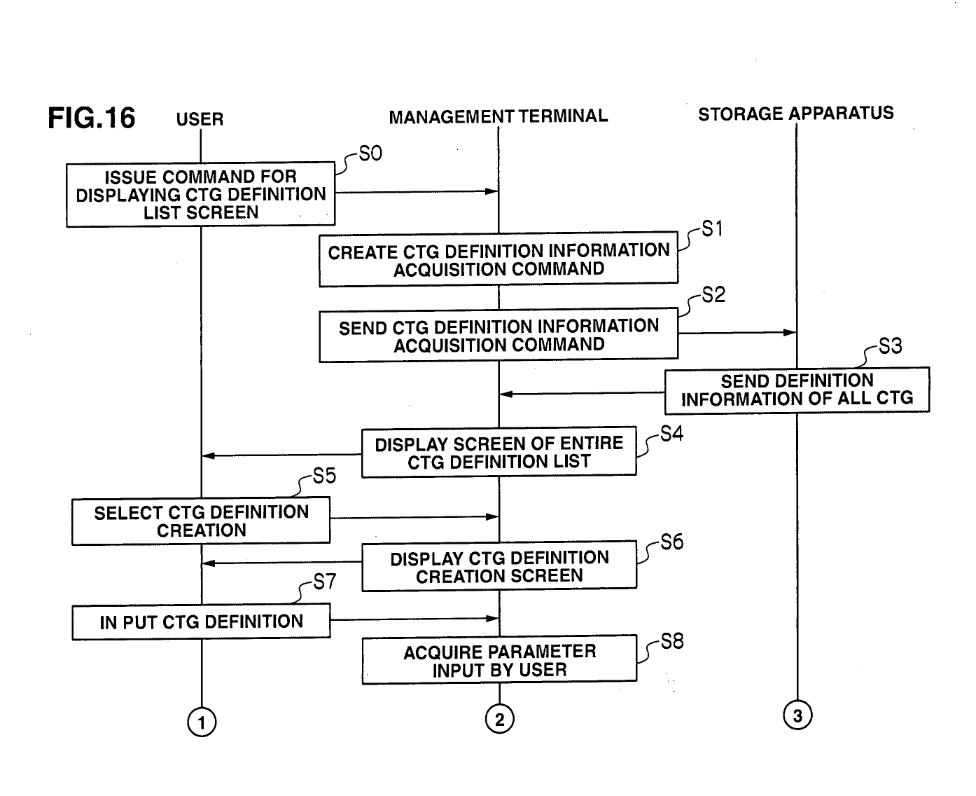

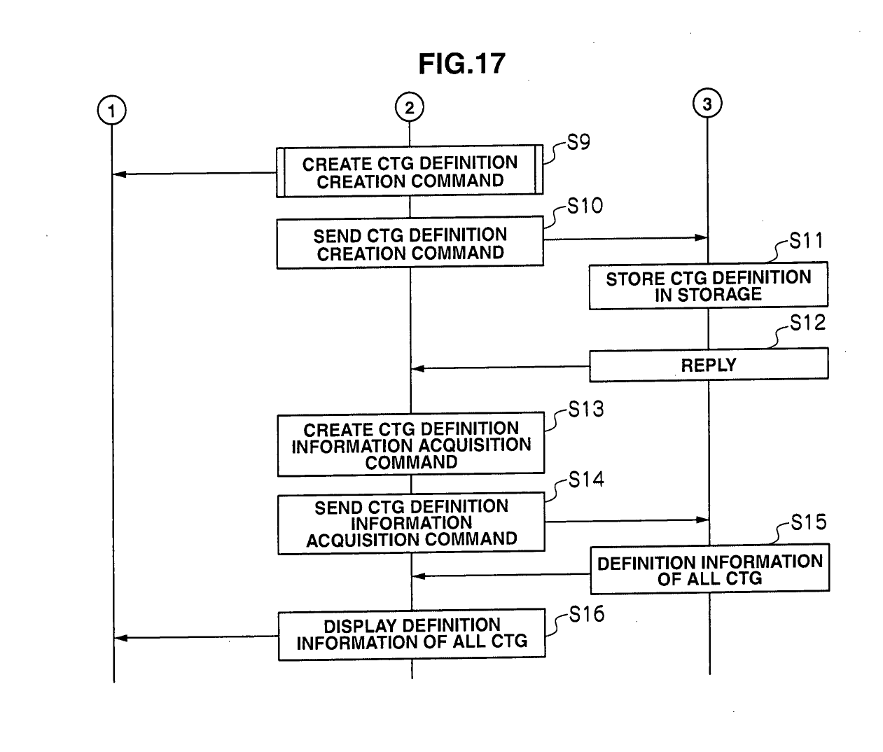

Specifically, as shown in FIG. 16 and FIG. 17, the user displays the consistency group definition screen G1 on the management terminal 6 (S1).

Then, the management terminal 6 creates a command for acquiring the consistency group definition information from the storage apparatus 4 (S1), and sends this command to the storage apparatus 4 (S2).

The storage apparatus 4 that received the command sends all consistency group definition information 730 stored in the local memory 73 to the management terminal 6 (S3). Here, since no information is stored as the consistency group definition information 730, the storage apparatus 4 sends only the information on the field name.

The management terminal 6 that received the consistency group definition information 730 displays all consistency group definition information 730 to the user. In other words, the management terminal 6 displays the consistency group definition list screen G1 to the user (S4).

Subsequently, the user clicks the “Create” button B1 from the displayed screen G1 (S5).

Then, the management terminal 6 displays the user consistency group definition creation screen G2 (S6).

The user inputs the “CTG number” and the “CTG name” from the displayed screen G2 and then clicks the “OK” button B4 (S7).

The management terminal 6 thereby acquires the parameters input by the user (S8), and creates a creation command of a consistency group definition based on the acquired parameters (S9). Incidentally, the method of creating the creation command of a consistency group definition will be described later.

The management terminal 6 that created the creation command of the consistency group definition sends the creation command to the storage apparatus 4 (S10).

The storage apparatus 4 that received the creation command creates a consistency group definition based on the creation command, and stores the created consistency group definition in the local memory 73 (S11).

Subsequently, the storage apparatus 4 sends a storage completion report to the management terminal 6 (S12).

The management terminal 6 that received the report creates an acquisition command for acquiring the consistency group definition information 730 (S13), and sends the created acquisition command to the storage apparatus 4 (S14).

The storage apparatus 4 that received the acquisition command retrieves all consistency group definition information 730 from the local memory 73, and sends such information 730 to the management terminal 6 (S15).

The management terminal 6 that received all consistency group definition information 730 displays the consistency group definition information 730 on the consistency group definition list chart H1 (S16). Here, since the consistency group is defined based on the values input by the user at step S7, when the user clicks the “CTG definition list” T10 shown in FIG. 7 once again, the defined consistency group is displayed on the list H1.

(1-4-2) Creation Processing of Creation Command for Consistency/Group Definition

The creation processing for creating the creation command concerning the consistency group definition at step S9 is now explained. The creation processing of the creation command is executed by the management terminal 6 based on the storage management program 60.

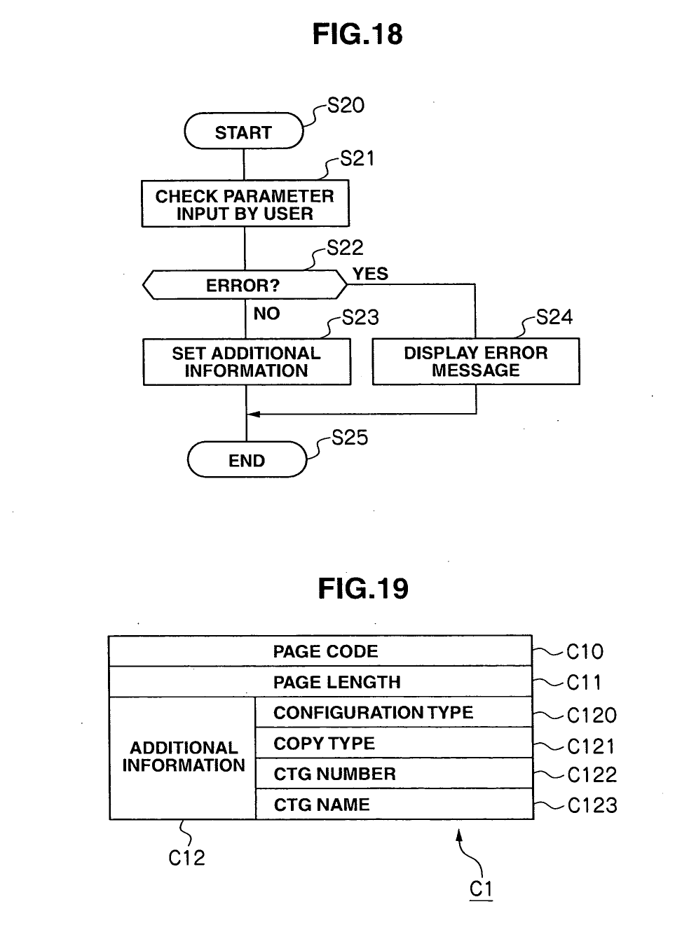

Specifically, as shown in FIG. 18, when the management terminal 6 acquires the parameters input by the user (S8), it starts the creation processing of the creation command concerning the consistency group definition (S20).

Foremost, the management terminal 6 checks the parameters input by the user (S21), and determines whether there is an error in such parameters (S22).

When the management terminal 6 determines that there is no error in the parameters input by the user (S22: NO), it sets a command between the management terminal 6 and the storage apparatus 4 for sending these parameters to the storage apparatus 4.

As shown in FIG. 19, the command between the management terminal 6 and the storage apparatus 4 is configured from a “page code” C10 as a predetermined command, a “page length” C11 as the command length, and “additional information” C12.

The additional information C12 will vary depending on the command to be set. At this step, since it is the additional information C12 of the creation command concerning the consistency group definition, this additional information C12 is configured from information concerning a “configuration type” C120 showing whether the configuration type is create, delete or change; a “copy type” C121 showing whether the copy type is shadow image, snapshot, true copy or asynchronous true copy, a “CTG number” C122 and a “CTG name” C123.

The management terminal 6 sets the additional information C12 (S23). Specifically, the management terminal 6 sets the “configuration type” C120 to “Create,” and sets the parameters input by the user to the “copy type” C121, the “CTG number” C122 and the “CTG name” C123 (S23).

Since the management terminal 6 created the creation command concerning the consistency group definition based on the foregoing setting, it ends the creation processing (S25).

Incidentally, when the management terminal 6 determines at step S22 that there is an error in the parameters input by the user (S22: YES), it displays an error message on the screen of the management terminal 6 (S24), and ends the creation processing (S25).

### (1-5) Storage Routine of Pair Definition Information

The processing routine for storing the pair definition information 731 in the storage apparatus 2 is now explained. This storage processing routine is executed by the management terminal 6 based on the storage management program 60.

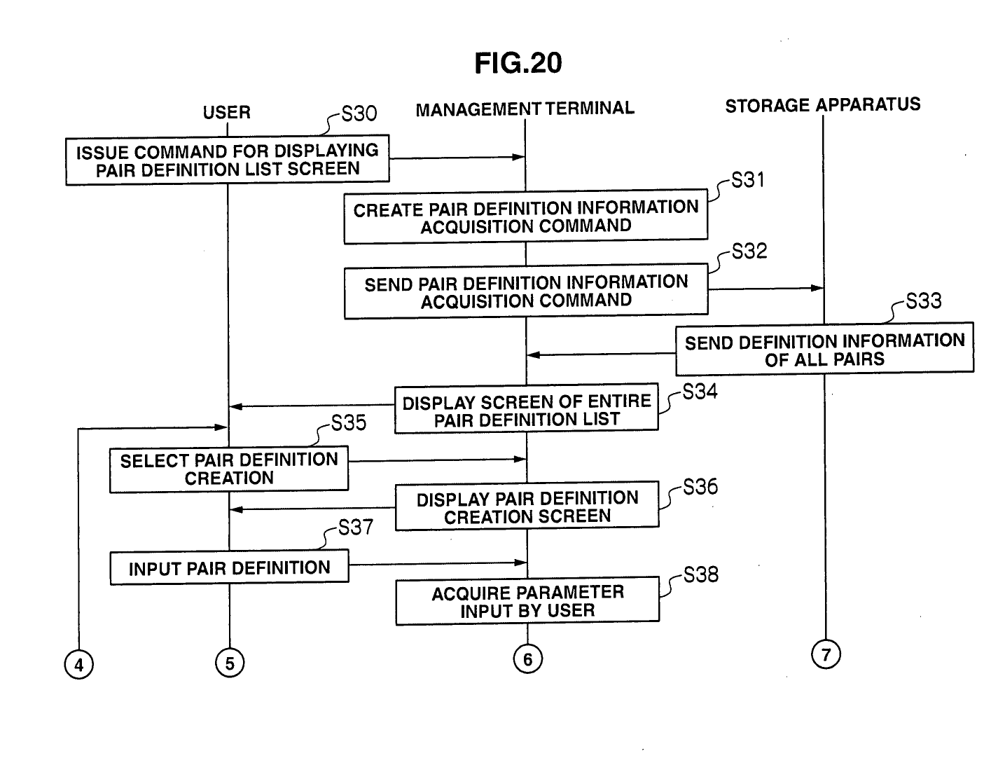

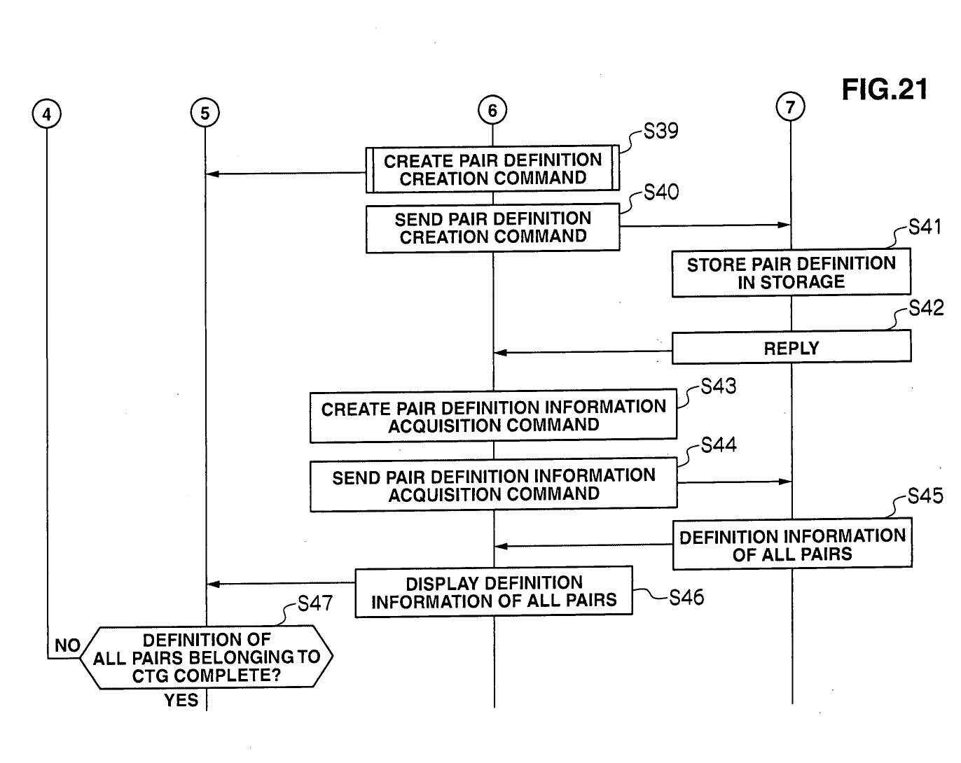

Specifically, as shown in FIG. 20 and FIG. 21, the user displays the pair definition screen G3 on the management terminal 6 (S30).

Subsequently, the storage routine of step S31 to S46 concerning the pair definition information 731 is performed according to the same processing routine as the storage routine steps S1 to S16 of the consistency group definition information described above.

Nevertheless, the management terminal 6 creates a command for acquiring the pair definition information, and the management terminal 6 and the storage apparatus 4 perform processing based on the pair definition information acquisition command (S31 to S34). In continuance, the management terminal 6 creates a pair definition creation command based on the parameters input by the user, and performs processing based on the pair definition creation command (S35 to S40).

The processing routine of the pair definition creation command C2 is now explained.

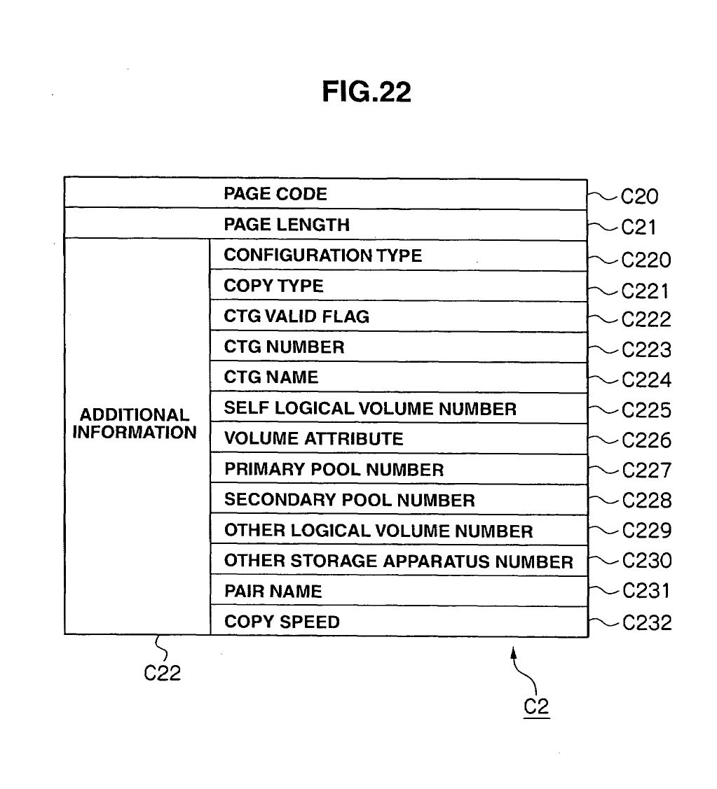

The processing routine of the pair definition creation command C2 is the processing routine of step S20 to S25 shown in FIG. 18. The pair definition creation command C2 to be sent between the management terminal 6 and the storage apparatus 4 is shown in FIG. 22.

The command between the management terminal 6 and the storage apparatus 4 is configured from a “page code” C20 as a predetermined command, a “page length” C21 as the command length, and “additional information” C22.

The additional information C22 is specifically configured from information concerning a “configuration type” C220, a “copy type” C221, a “CTG valid flag” C222 showing whether the pair belongs to a consistency group, a “CTG number” C223, a “CTG name” C224, a “self logical volume number” C225 showing its pair-defined logical volume number, a “volume attribute” C226, a “primary pool number” C227 showing the pool number to be used by the primary logical volume PVOL, a “secondary pool number” C228 showing the pool number to be used by the secondary logical volume PVOL, “another logical volume number” C229 showing the other pair-defined logical volume number, “another storage apparatus number” C230 showing the other pair-defined storage apparatus number, a “pair name” C231 showing the name to be given to the pair, and a “copy speed” C232 showing the copy speed upon copying data from the primary logical volume PVOL to the secondary logical volume SVOL.

Incidentally, since the “configuration type” C220 and the “copy type” C221 are the same as the “configuration type” C120 and the “copy type” C121, the explanation thereof is omitted.

Returning to FIG. 21, when the storage apparatus 4 stores the pair definition in the local memory 73, it once again creates a command for the management terminal 6 to acquire the pair definition information, and the management terminal 6 and the storage apparatus 4 perform processing based on the pair definition information acquisition command (S41 to S46).

When the user is to affiliate a plurality of pairs to the consistency group, the user determines whether the definition operation has been executed for all pairs (S47), and executes the definition operation until all pairs are subject to such definition operation (S47: NO). When the user determines that the definition operation of the plurality of pairs in the consistency group is complete (S47: YES), it ends the storage routine.

Incidentally, the creation processing of the creation command concerning the pair definition information is executed by the management terminal 6 based on the storage management program 60 as with the creation processing of the creation command concerning the consistency group definition information.

### (1-6) Processing Routine of Pair Creation

(1-6-1) Processing Routine of Pair Creation

The processing routine of creating a pair using the storage apparatus 4 storing the pair definition information 731 is now explained. The pair creation processing routine is executed by the management terminal 6 based on the storage management program 60.

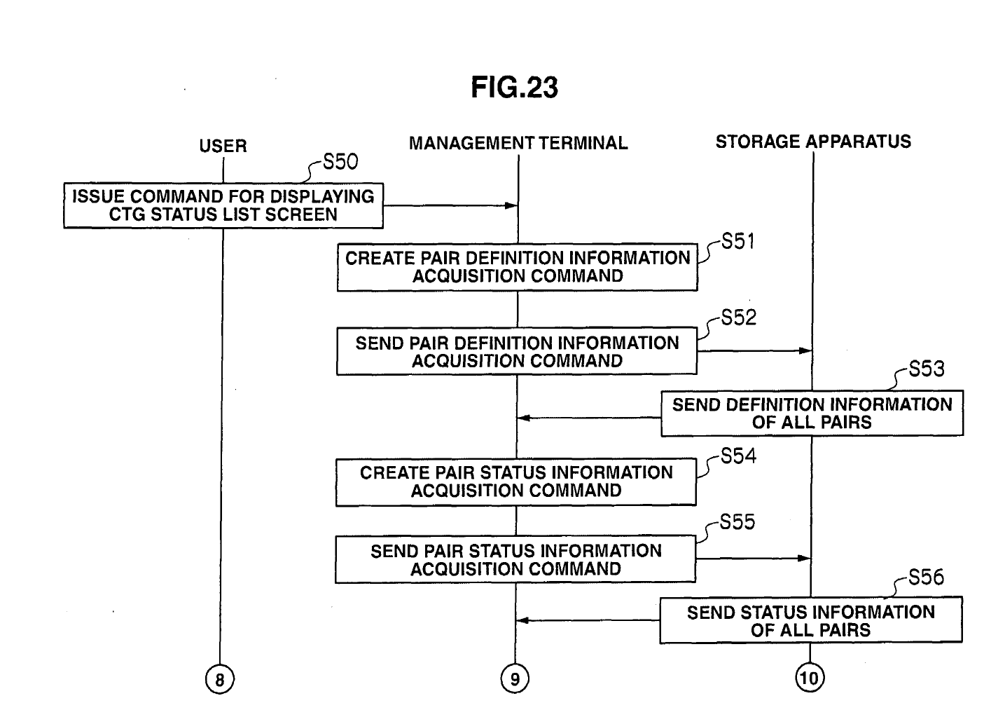

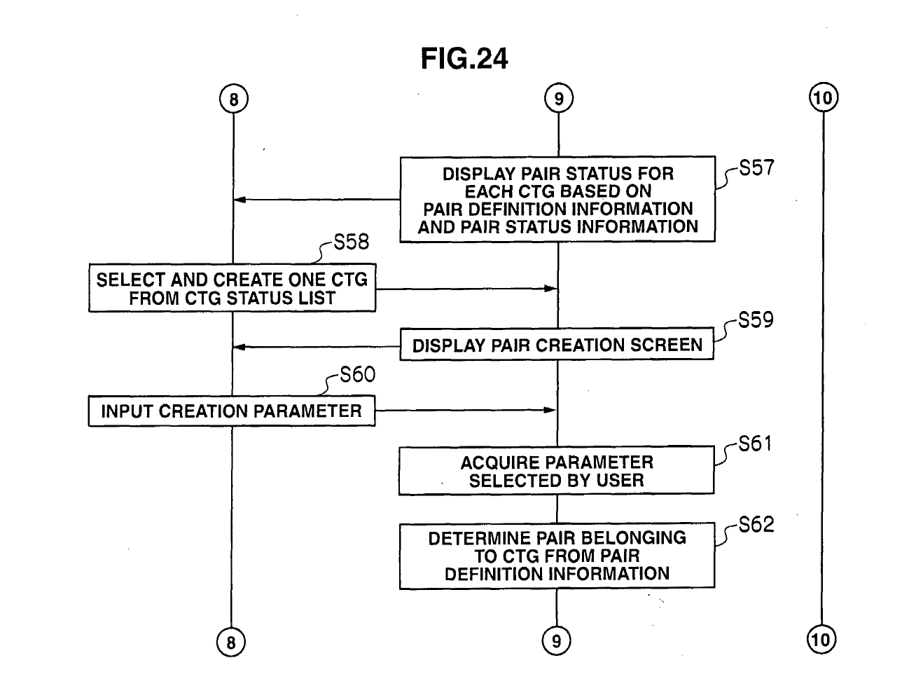

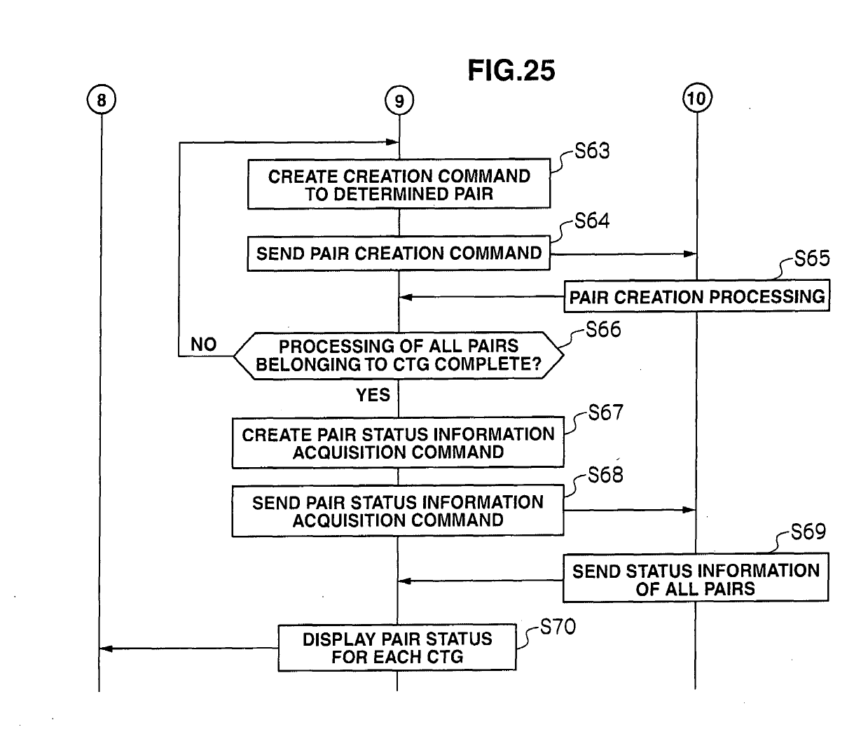

Specifically, as shown in FIG. 23 to FIG. 25, the user displays the consistency group status screen G5 on the management terminal 6 (S50).

The management terminal 6 or the storage apparatus 4 performs the processing routing of step S51 to step S53 as with the processing routine of step S31 to step S33.

The management terminal 6 creates a command for acquiring the pair status information 732 from the storage apparatus 4 (S54), and sends this command to the storage apparatus 4 (S55).

The storage apparatus 4 that received the command sends all pair status information 732 stored in the local memory 73 to the management terminal 6 (S56).

The management terminal 6 that received the pair status information 732 displays on the screen G5 the pair status for each consistency group based on the current pair definition information 731 and pair status information 732 (S57).

When the user checks one among the check buttons C5 to C8 to select one consistency group which such user wishes to create a pair from the displayed screen G5 and clicks the “Create” button B11 (S58), the management terminal 6 displays the pair creation screen G7 (S59).

The user selects the parameters B30 to B33 from the displayed pair creation screen G7 and clicks the “OK” button B34 (S60).

When the management terminal 6 acquires the parameters selected by the user (S61), it determines all pairs belonging to the consistency group from the pair definition information 731 (S62).

The management terminal 6 thereafter creates a pair creation command for creating the determined pairs in the storage apparatus 4 (S63), and sends this command to the storage apparatus 4 (S64).

The storage apparatus 4 that received the pair creation command creates a pair based on this command (S65). Subsequently, the storage apparatus 4 sends a reply to the management terminal 6 indicating that the pairs have been created normally or the creation of such pairs ended in failure. Incidentally, the pair creation processing to be executed by the storage apparatus 4 is described later.

The management terminal 6 that received a reply from the storage apparatus 4 determines whether the pair creation of all pairs belonging to the consistency group determined at step S62 is complete (S66).

When the management terminal 6 determines that the pair creation of all pairs belonging to the consistency group is not complete (S66: NO), it returns to step S63 once again and creates a pair creation command for the subsequently determined pair.

Meanwhile, when the management terminal 6 determines that the pair creation of all pairs belonging to the consistency group is complete (S66: YES), the management terminal 6 subsequently creates an acquisition command for acquiring the pair status information 732 from the storage apparatus 4 since the new pair in which the initial copy was started has already been updated in the pair status information 732 based on the pair creation (S67).

After creating the acquisition command, the management terminal 6 sends this command to the storage apparatus 4 (S68).

The storage apparatus 4 that received this acquisition command sends all pair status information 732 stored in the local memory 73 to the management terminal 6 (S69).

The management terminal 6 that received all pair status information 732 displays the screen G5 as the pair status information to the user (S70), and ends this creation routine after confirming that all pairs belonging to the consistency group selected by the user have been created.

Incidentally, the various commands described above are sent and received according to the SCSI specification.

(1-6-2) Pair Creation Processing

The pair creation processing to be performed by the storage apparatus 4 at step S65 of the pair creation processing routine is now explained. This pair creation processing is executed by the CPU 72 of the storage apparatus 4 based on the pair creation program 734.

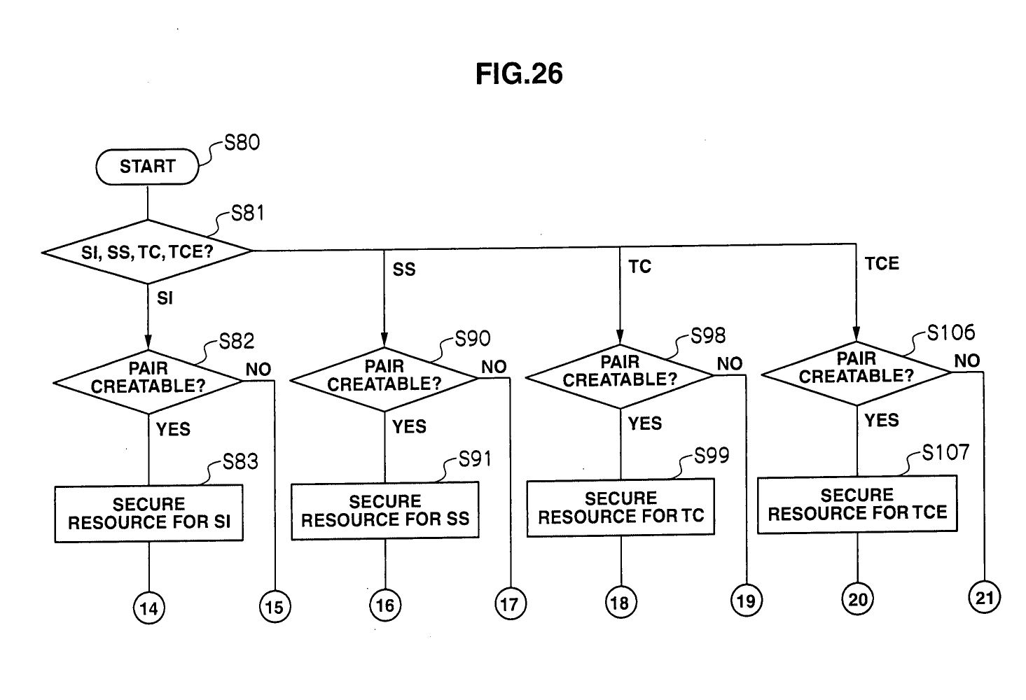

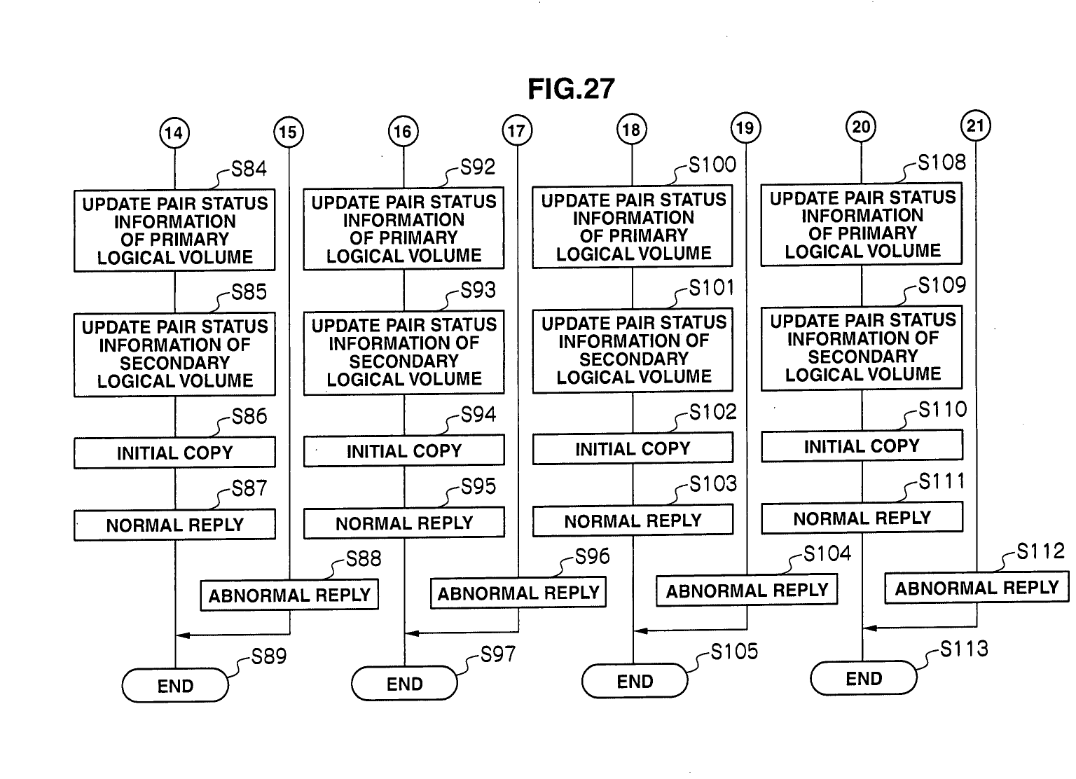

Specifically, as shown in FIG. 26 and FIG. 27, the CPU 72 of the storage apparatus 4 starts the pair creation processing upon receiving a pair creation command from the management terminal 6 (S80). At this stage, only pair definition is performed in this status.

The CPU 72 determines whether the pair creation was based on the copy type of shadow image, snapshot, true copy or asynchronous true copy from the received pair creation command (S81).

When the CPU 72 determines that the pair creation is for a shadow image (S81: SI), it determines whether the logical volume VOL designated by the pair creation command has a storage area in which a pair can be created (S82).

When the CPU 72 determines that the logical volume VOL has a storage area in which a pair can be created (S82: YES), it secures a resource for such shadow image as the storage area in which a pair can be created (S83). This resource is a pair (one pair of primary logical volume PVOL and secondary logical volume SVOL) resource, and refers to the storage area or the like of a pair for managing the differential. As a result of securing this resource, the preparation is now ready for copying the data in the primary logical volume PVOL to the secondary logical volume SVOL.

The CPU 72 that secured the resource updates the pair status information 730 corresponding to the primary logical volume PVOL (S84).

Specifically, the CPU 72 updates the pair status 7320 of the pair status information 732 to “copying,” and the volume attribute 7321 to “primary logical volume.” Further, the CPU 72 inputs the “user input value” to the CTG valid flag 7322, the CTG number 7323 and the various parameters 7328.

Subsequently, the CPU 72 updates the pair status information 732 corresponding to the secondary logical volume SVOL (S85).

Specifically, the CPU 72 sets the pair status 7320 of the pair status information 732 to “creating,” the volume attribute 7321 to “secondary logical volume,” and inputs the P-VOL number 7324 in the “primary logical volume PVOL number.” Further, the CPU 72 inputs the “user input value” to the CTG valid flag 7322, the CTG number 7323, the P-VOL identification number 7325 and the various parameters 7328.

After the update, the CPU 72 copies the data in the primary logical volume PVOL to the secondary logical volume SVOL based on initial copy, and then executes pair creation (S86).

After starting the initial copy, the CPU 72 sends a reply to the management terminal 6 indicating that the copy started normally (S87), and then ends the pair creation processing (S89).

Meanwhile, when the CPU 72 determines at step S82 that the logical volume VOL does not have a storage area in which a pair can be created (S82: NO), it sends an abnormal reply to the management terminal 6 indicating that the copy ended in a failure (S88), and then ends the pair creation processing (S89).

Returning to step S81, when the CPU 72 determines that the pair creation is for a snapshot (S81: SS), it performs the processing of step S90 to step S97 according to the same processing routine as the processing of step S82 to step S89.

Returning once again to step S81, when the CPU 72 determines that the pair creation is for a true copy (S81: TC), it performs the processing of step S98 and step S99 according to the same processing routine as the processing of step S82 and step S83, and thereby secures the resource for a true copy (S99).

The CPU 72 that secured the resource for a true copy updates the pair status information 730 according to the primary logical volume PVOL (S100).

Specifically, the CPU 72 updates the pair status 7320 of the pair status information 732 to “copying,” and the volume attribute 7321 to “primary logical volume.” In addition, the CPU 72 inputs the “secondary logical volume number and secondary storage apparatus number” in the other logical volume 7326. Further, the CPU 72 inputs the “user input value” to the CTG valid flag 7322, the CTG number 7323 and the various parameters 7328.

Subsequently, the CPU 72 updates the pair status information 730 corresponding to the secondary logical volume SVOL (S101).

Specifically, the CPU 72 sets the pair status 7320 of the pair status information 732 to “copying,” the volume attribute 7321 to “secondary logical volume,” and inputs the “primary logical volume PVOL number” in the P-VOL number 7324. Further, the CPU 72 inputs the “user input value” in the CTG valid flag 7322, the CTG number 7323, the P-VOL identification number 7325 and the various parameters 7328.

After the update, the CPU 72 performs initial copy of data in the primary logical volume PVOL to the secondary logical volume SVOL, and executes pair creation (S102).

After starting the initial copy, the CPU 72 sends a reply to the management terminal 6 indicating that the copy has been started normally (S103), and ends the pair creation processing (S105).

Meanwhile, at step S98, when the CPU 72 determines that the logical volume VOL does not have a storage area in which a pair can be created (S98: NO), it sends an abnormal reply to the management terminal 6 indicating that the normal copy ended in a failure (S104), and ends the pair creation processing (S105).

Returning to step S81, when the CPU 72 determines that the process is a pair creation for asynchronous true copy (S81: TCE), it performs the processing at step S106 to S113 according to the same processing routine as the processing at step S98 to S105.

### (1-7) Effect of First Embodiment

According to the present embodiment, since definition information concerning the pair configuration can be shared as a result of storing such definition information concerning the pair configuration in a storage apparatus, the takeover of definition information can be facilitated even when another management terminal is connected to the storage apparatus.

Further, according to the present embodiment, since definition information concerning the pair configuration is stored in the storage apparatus, operability concerning the pair configuration can be simplified from the management terminal.

Moreover, according to the present embodiment, since security information is stored in the storage apparatus, the actual logical volume number can be converted into a logical volume number to be managed in the host system when defining a pair, and provided to the host system. Thus, since the user will be able to select the logical volume number to be managed in the host system, it is possible to improve the user-friendliness of users who usually select logical volumes from the perspective of the host system.

### (2) Other Embodiments

Incidentally, although the storage management program 60 was stored in the management terminal 6 in the foregoing embodiment, since the consistency group definition information or pair definition information can be stored in the storage apparatus 4 so as long as the program 60 is installed, it is not limited to being stored in the management terminal 6. If the host system 2 stores the storage management program 60, the host system may, in substitute for the management terminal 6, realize the foregoing embodiments.

Further, although the storage unit to store the consistency group definition information 730 and pair definition information 731 was provided in the local memory 73, the storage unit may also be configured as individual hardware.

The present invention can be broadly applied to storage systems including one or more storage controllers, and storage systems of various other embodiments.

What is claimed is:

1. A storage system comprising:
one or more storage controllers configured to store data sent from a host system, and
a management terminal configured to manage the input and output of data stored in and from said one or more storage controllers,
wherein said one or more storage controllers have two or more logical volumes to be pair-configured in a storage area of a plurality of hard disk drives, and include a storage unit for storing as pair definition information the status of not executing initial copy of data to be stored in a pair-configured copy source logical volume to a copy destination logical volume based on a command from said management terminal.

2. The storage system according to claim 1,
wherein said storage unit further stores as group definition information a plurality of pair-configured logical volumes for operating a plurality of pair configurations as group units in said management terminal.

3. The storage system according to claim 1,
wherein said management terminal displays said pair definition information on a display screen, and pair creation is executed by selecting an arbitrary command displayed on said display screen.

4. The storage system according to claim 1,
wherein, when said management terminal creates a creation command for creating said pair definition information based on an input pair definition parameter and sends said creation command to said storage controller,
said storage controller creates said pair definition information based on said creation command from said management terminal, and stores said created pair definition information in said storage unit.

5. The storage system according to claim 4,
wherein said pair definition parameter is a pair name, a logical volume number of a copy source, and a logical volume number of a copy destination.

6. The storage system according to claim 2,
wherein, when said management terminal creates a creation command for creating said group definition information based on an input group definition parameter and sends said creation command to said storage controller,
said storage controller creates said group definition information based on said creation command from said management terminal, and stores said created group definition information in said storage unit.

7. A data management method of a storage system comprising:
one or more storage controllers configured to store data sent from a host system, and
a management terminal configured to manage the input and output of data stored in and from said one or more storage controllers,
wherein said one or more storage controllers include a step of forming two or more logical volumes to be pair-configured in a storage area of a plurality of hard disk drives, and a step of storing as pair definition information the status of not executing initial copy of data to be stored in a pair-configured copy source logical volume to a copy destination logical volume based on a command from said management terminal.

8. The data management method according to claim 7,
wherein at said storage step, a plurality of pair-configured logical volumes for operating a plurality of pair configurations as group units in said management terminal is further stored as group definition information.

9. The data management method according to claim 7,
wherein said management terminal displays said pair definition information on a display screen, and pair creation is executed by selecting an arbitrary command displayed on said display screen.

10. The data management method according to claim 7,
wherein said management terminal creates a creation command for creating said pair definition information based on an input pair definition parameter and sends said creation command to said storage controller; and
said storage controller creates said pair definition information based on said creation command from said management terminal, and stores said created pair definition information in said storage unit.

11. The data management method according to claim 10,
wherein said pair definition parameter is a pair name, a logical volume number of a copy source, and a logical volume number of a copy destination.

12. The data management method according to claim 8,
wherein said management terminal creates a creation command for creating said group definition information based on an input group definition parameter and sends said creation command to said storage controller; and
said storage controller creates said group definition information based on said creation command from said management terminal, and stores said created group definition information in said storage unit.
